(19) United States
(12) Patent Application Publication
(10) Pub. No.: US 2026/0252161 A1
(43) Pub. Date: Aug. 27, 2026

(54) Systems and Methods for Power Gating Chip Components

(71) Applicant: SiFive, Inc., San Mateo, CA (US)

(72) Inventors: Edward Mclellan, Holliston, MA (US); Henry Cook, Berkeley, CA (US); Arjun Pal Chowdury, Austin, TX (US)

(21) Appl. No.: 18/577,335

(22) PCT Filed: Jun. 24, 2022
(86) PCT No.: PCT/US2022/034821

§ 371 Date: Jan. 8, 2024

Related U.S. Application Data
(60) Provisional application No. 63/221,208, filed on Jul. 13, 2021.

(51) Int. Cl. G06F 1/3287; G06F 1/3234

(52) U.S. Cl. CPC G06F 1/3287; G06F 1/3243

(57) ABSTRACT

Described are systems and methods for power gating components on a system-on-chip. A processing system includes a cluster including one or more cores, a power domain sequencer, and a power management unit connected to the cluster, the one or more cores, and the power domain sequencer. The power management unit configured to receive a power down ready notification from a core of the one or more cores, and process a set of bus blockers to block transactions to and from the core, where a bus blocker is associated with a port on an interconnection network connected to the one or more cores, uncore components, and the cluster. The power domain sequencer configured to power down the core when receiving a notification from the power management unit that the set of bus blockers are quiescent.

### TECHNICAL FIELD

This disclosure relates to power management and in particular, power gating cores, clusters, caches, and other components on a chip or on a system-on-chip (SoC).

### BACKGROUND

Power is tied to overall SoC performance including, but not limited to, battery life, energy consumption, thermal profile, cooling requirements, noise profile, system stability, sustainability, and operational costs. Power management techniques can be used to control power consumption by controlling the clock rate and by using voltage scaling, power gating, and other techniques.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a processing system for implementing power gating in accordance with embodiments of this disclosure.

FIG. 2 is a block diagram of an example of a bus blocker for implementing power gating in accordance with embodiments of this disclosure.

FIG. 3 is a block diagram of an example of a state machine for use with external hardware for implementing power gating in accordance with embodiments of this disclosure.

FIG. 4 is a block diagram of an example of a processing system for implementing power gating in accordance with embodiments of this disclosure.

FIG. 5 is a flowchart of an example technique or method power gating in accordance with embodiments of this disclosure.

FIG. 6 is a flowchart of an example technique or method power gating in accordance with embodiments of this disclosure.

FIG. 7 is a flowchart of an example technique or method power gating in accordance with embodiments of this disclosure.

FIG. 8 is a block diagram of an example of a processing system for implementing power gating in accordance with embodiments of this disclosure.

FIG. 9 is a flow diagram of an example of a power gate sequence for use with the finite state machine power management controller of FIG. 8 in accordance with embodiments of this disclosure.

FIG. 10 is a block diagram of an example of a finite state machine for use with the finite state machine power management controller of FIG. 8 in accordance with embodiments of this disclosure.

### DETAILED DESCRIPTION

Disclosed herein are systems and methods for power gating cores, clusters, caches, and other components on a chip or on a system-on-chip (SoC). Power gating is a method for isolating and removing power from a portion of an SoC while other portions remain fully powered and functional. The purpose of power gating is to eliminate all or substantially all static and dynamic power from portions of a design that are not needed for a period of time. For example, per-core or per-tile power gating can remove an idle core from the power rail and per-cluster power gating can remove all cores within a cluster plus the uncore components from the power rail, which in some implementations can include removing a last level cache from the power rail.

An aspect includes a processing system with a cluster including one or more cores, a power domain sequencer, and a power management unit connected to the cluster, the one or more cores, and the power domain sequencer. The power management unit configured to receive a power down ready notification from a core of the one or more cores and process a set of bus blockers to block transactions to and from the core, wherein a bus blocker is associated with a port on an interconnection network connected to the one or more cores, uncore components, and the cluster. The power domain sequencer configured to power down the core when receiving a notification from the power management unit that the set of bus blockers are quiescent.

An aspect includes a method for power gating. The method including receiving, at a power management unit, a power down ready notification from a core which is ready to power down, processing, by the power management unit, a set of bus blockers to block transactions to and from the core, where a bus blocker is associated with a port on an interconnection network connected to the core, and powering down, by a power domain sequencer in cooperation with the power management unit, the core when the set of bus blockers are quiescent.

An aspect includes a method for power gating. The method includes receiving, at a power management unit, a power down ready notification from a first entity that a second entity is ready to power down, sequentially activating and polling, by the power management unit, each bus blocker in a set of bus blockers associated with the second entity after a second entity internal power down sequence is complete, and notifying, a power domain sequencer by the power management unit when the set of bus blockers are quiescent, to power down the second entity.

These and other aspects of the present disclosure are disclosed in the following detailed description, the appended claims, and the accompanying figures.

As used herein, the terminology “processor” indicates one or more processors, such as one or more special purpose processors, one or more digital signal processors, one or more microprocessors, one or more controllers, one or more microcontrollers, one or more application processors, one or more central processing units (CPU) s, one or more graphics processing units (GPU) s, one or more digital signal processors (DSP) s, one or more application specific integrated circuits (ASIC) s, one or more application specific standard products, one or more field programmable gate arrays, any other type or combination of integrated circuits, one or more state machines, or any combination thereof.

The term “circuit” refers to an arrangement of electronic components (e.g., transistors, resistors, capacitors, and/or inductors) that is structured to implement one or more functions. For example, a circuit may include one or more transistors interconnected to form logic gates that collectively implement a logical function. For example, the processor can be a circuit.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices and methods shown and described herein.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

It is to be understood that the figures and descriptions of embodiments have been simplified to illustrate elements that are relevant for a clear understanding, while eliminating, for the purpose of clarity, many other elements found in typical processors. Those of ordinary skill in the art may recognize that other elements and/or steps are desirable and/or required in implementing the present disclosure. However, because such elements and steps do not facilitate a better understanding of the present disclosure, a discussion of such elements and steps is not provided herein.

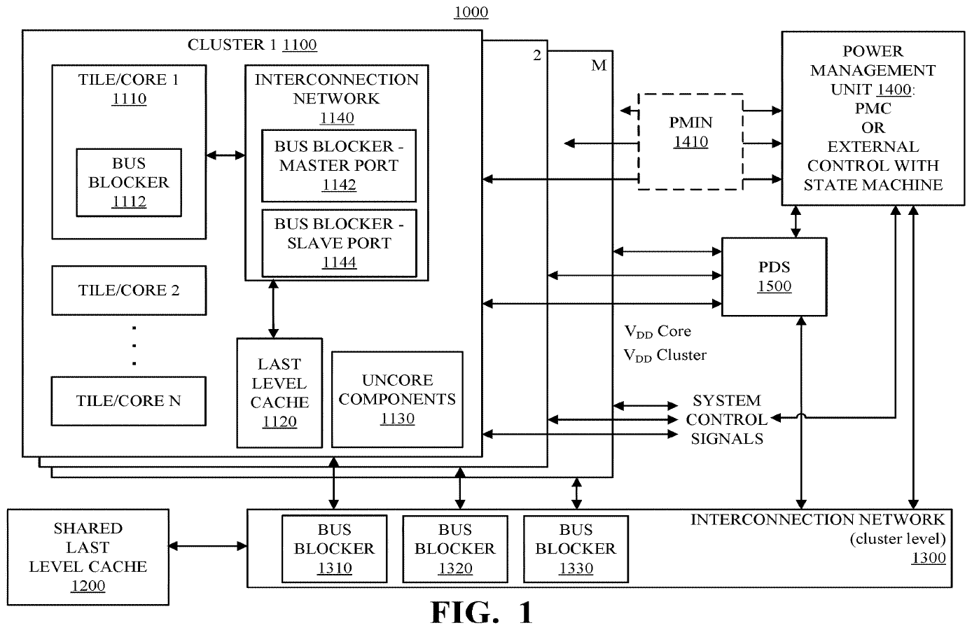

FIG. 1 is a block diagram of an example of a processing system 1000 for implementing power gating in accordance with embodiments of this disclosure. The processing system 1000 can implement a pipelined architecture. The processing system 1000 can be configured to decode and execute instructions of an instruction set architecture (ISA) (e.g., a RISC-V instruction set). The instructions can execute speculatively and out-of-order in the processing system 1000. The processing system 1000 can be a compute device, a microprocessor, a microcontroller, or an IP core. The processing system 1000 can be implemented as an integrated circuit. The processing system 1000 and each element or component in the processing system 1000 is illustrative and can include additional, fewer or different devices, entities, element, components, and the like which can be similarly or differently architected without departing from the scope of the specification and claims herein. Moreover, the illustrated devices, entities, element, and components can perform other functions without departing from the scope of the specification and claims herein.

The processing system 1000 includes one or more clusters 1, 2, . . . , M 1100. For example, M can be 32. The one or more clusters 1, 2, . . . , M 1100 can be interconnected to or be in communication with (collectively “interconnected to”) each other and connected to or be in communication with (collectively “connected to”) a shared last level cache 1200 via an interconnection network 1300 (this chip level can be referred to as a complex). The shared last level cache 1200 can be shared amongst the one or more clusters 1, 2, . . . , M 1100. The interconnection network 1300 can include a bus blocker 1310, 1320, and 1330, respectively, for each of the one or more clusters 1, 2, . . . , M 1100, where each bus blocker 1310, 1320, and 1330 can be one or more bus blockers. For example, there can be bus blockers corresponding to the last level cache 1120, the shared last level cache 1200, and each component in the uncore components 1130. A power management unit 1400 and a power domain sequencer 1500 can be connected to each other and to each of the one or more clusters 1, 2, . . . , M 1100. The power management unit 1400 can be a power microcontroller (PMC) and/or external hardware or logic with a state machine as described herein. The power domain sequencer 1500 can be a microcontroller, a controller, and an external hardware or logic.

Each of the one or more clusters 1, 2, . . . , M 1100 can include one or more cores 1, 2, . . . , N 1110 which can be connected to each other, to a last level cache 1120, and to uncore components 1130 via an interconnection network 1140. For example, N can be 4. The one or more cores 1, 2, . . . , N 1110 can also be referred to as a tile. The last level cache 1120 can be shared amongst the one or more cores 1, 2, . . . , N 1110. The uncore components 1130 can include, but is not limited to, clock circuits, interrupt controllers and circuits, debug circuits, debug manager, wrappers, command line interrupt circuits and controllers, cache coherence manager, and caches. Each of the one or more cores 1, 2, . . . , N 1110 can include a bus blocker 1112. The interconnection network 1140 can include a bus blocker 1142 associated with a master port or interface and a bus blocker 1144 associated with a slave port or interface.

The interconnection network 1300 and the interconnection network 1140 can be a chip-scale interconnect such as TileLink. TileLink is a chip-scale interconnect standard providing multiple masters with incoherent or coherent memory mapped access to memory and other slave devices. TileLink can connect cores, clusters, general-purpose multiprocessors, co-processors, accelerators, DMA engines, and simple or complex devices (collectively “entities”), using a fast scalable interconnect providing both low-latency and high throughput transfers. TileLink is defined in terms of a graph of connected agents that send and receive messages over point-to-point channels within a link to perform operations on a shared address space, where an agent is an active participant that sends and receives messages in order to complete operations, a channel is a one-way communication connection between a master interface (port) and a slave interface carrying messages of homogeneous priority, and a link is a set of channels required to complete operations between two agents. In a pair of connected entities, one entity can include an agent with a master interface and the other entity can include an agent with a slave interface. The agent with the master interface can request the agent with the slave interface to perform memory operations, or request permission to transfer and cache copies of data. The agent with the slave interface manages permissions and access to a range of addresses, wherein it performs memory operations on behalf of requests arriving from the master interface. A request must always receive a response. Consequently, one entity cannot be powered down while the other entity is powered on.

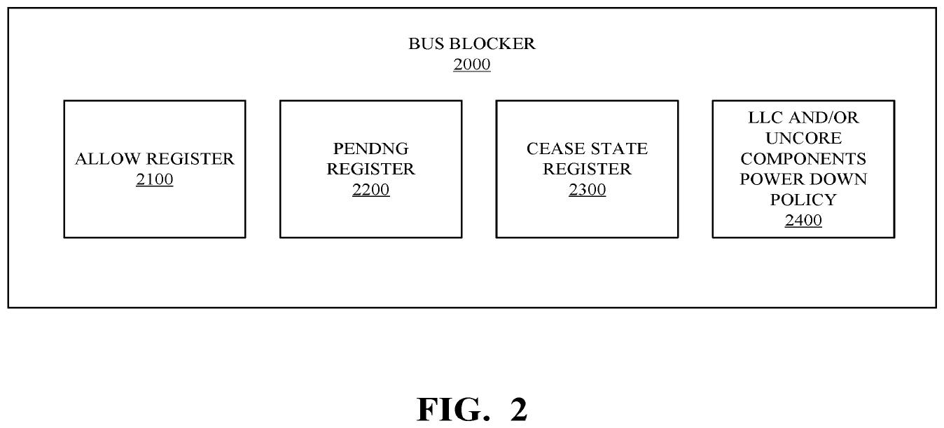

A bus blocker, such as the bus blockers 1112, 1142, 1144, 1310, 1320, and 1330, can include registers, circuitry, and logic to maintain information and determine whether an entity associated with or corresponding to the bus blocker can be power gated. The bus blocker can report, via a signal or register polling, a status of the associated entity with respect to pending transactions or operations. FIG. 2 is a block diagram of an example of a bus blocker 2000 for implementing power gating in accordance with embodiments of this disclosure. Each of the bus blockers, such as the bus blockers 1112, 1142, 1144, 1310, 1320, and 1330, can be implemented as the bus blocker 2000. The bus blocker 2000 can include an allow register 2100, a pending register 2200, a CEASE state register 2300, and a last level cache power down policy register 2400. In implementations, the bus blocker 2000 may exclude the CEASE state register 2300 and the last level cache power down policy register 2400 if a bus blocker common to a group of cores or shares an uncore unit with or without cache has the CEASE state register 2300 and the last level cache power down policy register 2400. This avoids redundancy.

The bus blocker 2000 is illustrative and can include additional, fewer, or different registers, circuits, logic, devices, entities, element, components, and the like which can be similarly or differently architected without departing from the scope of the specification and claims herein. Moreover, the illustrated circuits, devices, entities, element, and components can perform other functions without departing from the scope of the specification and claims herein.

The allow register 2100 and circuitry can enable or disable the passage of transactions sent on the interconnection network as between two entities. The allow register can be set by the power management unit 1400. For example, the allow register 2100 can be a one or more bit field, which can be set to enable or disable bus transactions. The pending register 2200 and circuitry can identify or indicate if transactions are pending, in-flight, and/or complete as between two entities. For example, the pending register 2200 can be a n bit field, which can be set to indicate if bus transactions are in-flight. For example, n can be 32. In implementations, the pending register 2200 is a counter. In implementations, the pending register 2200 is backed up by a counter. The CEASE state register 2300 can identify a CEASE state status for all cores in a cluster. For example, the CEASE state register 2300 can be a m bit field which can identify a cease state for all cores in a cluster. For example, m can be 8. The last level cache power down policy register 2400 can determine which action to take with respect to uncore components when a last core in a cluster is power gated. The actions can include, but are not limited to, leave the uncore components powered up and functional, flush a cache such as a last level cache, and power down the uncore components (effectively powering down the cluster), and/or functionally isolating the cluster and the last level cache in a state retention mode, but allowing transient power-up periods for cache operations. In implementations, a cache shared by multiple clusters in a complex can be partially powered down with respect to specific regions or addresses in the shared cache. For example, the last level cache power down policy register 2400 can be a p bit field. For example, p can be 2 bits.

The power management unit 1400 can provide control outside of the power domain (e.g., the core and/or cluster) being powered down to determine when all bus activity has completed and the domain is functionally isolated. The power management unit 1400 can communicate with the managed cores and/or clusters and bus blockers through the interconnection networks such as the interconnection network 1300 and the interconnection network 1140, via direct signals (e.g., cease_from_tile_x) (i.e., addition of dedicated connections to and from the power management unit 1400 to each bus blocker), or combinations thereof. That is, power management is done over a shared interconnection network which is also used for data. In implementations, the power management unit 1400 can communicate with the bus blockers through power management interconnection network (PMIN) 1410, which can be an interconnection network similar to the interconnection network 1300 and the interconnection network 1140 but is dedicated to power management. The power management unit 1400 can read and write registers in the bus blockers via the PMIN 1410. The PMIN 1410 can provide a layer of security as the power management unit 1400 can operate in a secure environment.

The power management unit 1400 can communicate with the power domain sequencer 1500 or similar logic to manage power delivery to the managed domains. As noted previously, the power management unit 1400 can be a power microcontroller (PMC) and/or external hardware or logic with a state machine. For example, larger cores and multi-core clusters can use the PMC which can provide more flexibility and support for future capabilities, and single or small cores with few ports can use the external hardware or logic with a state machine.

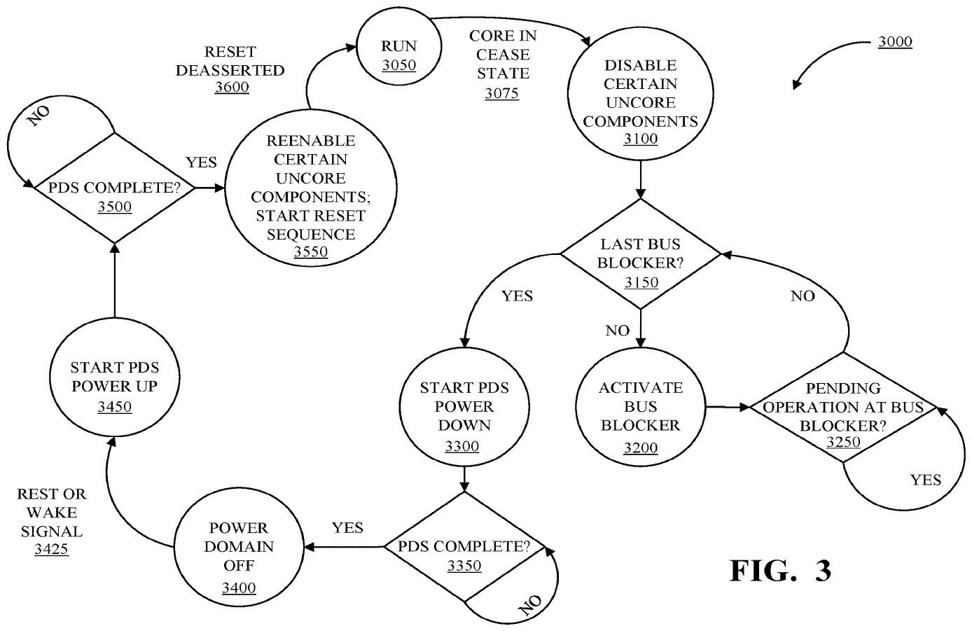

FIG. 3 is a block diagram of an example of a state machine 3000 for use with external hardware for implementing power gating in accordance with embodiments of this disclosure. The state machine 3000 can be implemented as hardware, software, and/or combinations thereof to sequence power states of a core. As described herein, bus blockers can be used to ensure that the core or cluster (collectively “domain”) is removed from the system or SoC on a power basis. The state machine 3000 is illustrative and can include additional, fewer, or different states and messages, and which can be similarly or differently architected without departing from the scope of the specification and claims herein. Moreover, the illustrated states and messages can perform other functions without departing from the scope of the specification and claims herein.

The initial state of the state machine 3000, for purposes of discussion convenience, is when a core is in a run state 3050. The core can execute a CEASE instruction and send a notification 3075 to the external hardware upon retirement of the CEASE instruction. This is further described herein below. The external hardware can initiate disabling of the clocks, debug controller or mechanisms, and other similar functions (3100). The external hardware can then determine if the bus blocker reporting no pending transactions is the last bus blocker for the core (3150) (as further described herein). If this is not the last bus blocker, then the external hardware can enable an allow register for this bus blocker (3200). The external hardware can then poll or otherwise obtain from a pending register of the bus blocker, notification of any pending transactions (3250). The polling, for example, can continue until no pending transactions are reported. If no pending transactions are reported, and this is the last bus blocker for the core, the external hardware can notify the power domain sequencer 1500, for example, to initiate the power down sequence (3300). The power domain sequencer 1500 can cyclically or loop-wise determine if the power down sequence is complete (3350). If the power down sequence is complete, the core is then in a off state 3400. If the core then receives a reset or wake signal 3425, the power domain sequencer 1500 can initiate a power up sequence (3450). The power domain sequencer 1500 can cyclically or loop-wise determine if the power up sequence is complete (3500). If the power up sequence is complete, the external hardware can initiate enabling of the clocks, debug controller or mechanisms, and other similar functions (3550). The reset signal can be de-asserted (3600) and the core can return to a run state 3050.

The power domain sequencer 1500 can gradually and/or sequentially enable and disable connections between the core and/or cluster power input and a global supply rail (shown as V_{DD} Core and V_{DD} Cluster signals). In implementations, external circuitry and/or systems, in cooperation with the power management unit 1400 and power domain sequencer 1500, can provide control signals to enable and disable the clocks, provide reset signals, and other similar functionality.

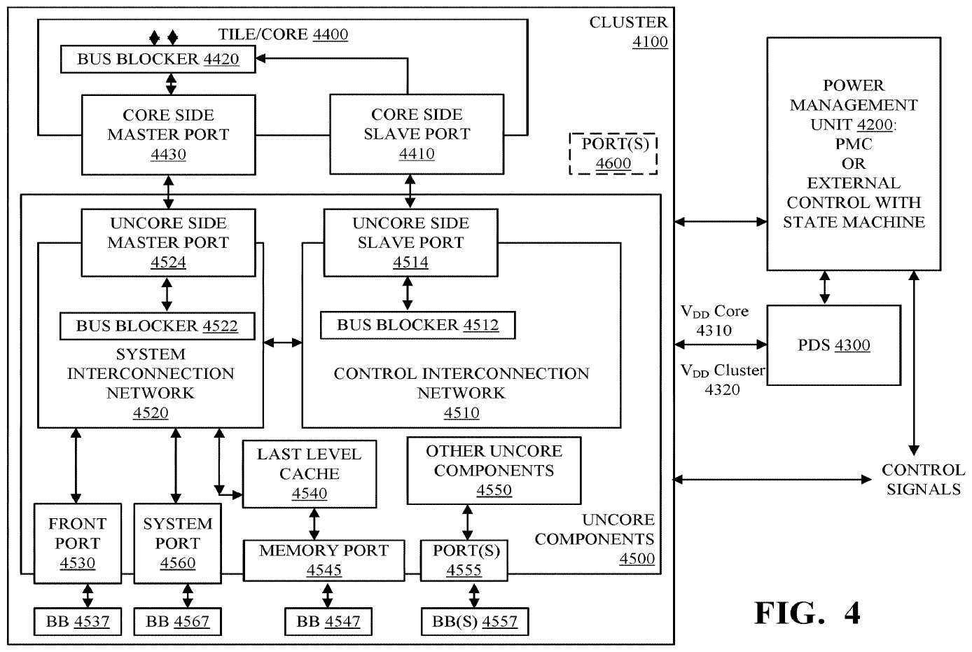

FIG. 4 is a block diagram of an example of a processing system 4000 for implementing power gating in accordance with embodiments of this disclosure. The processing system 4000 can implement a pipelined architecture. The processing system 4000 can be configured to decode and execute instructions of an instruction set architecture (ISA) (e.g., a RISC-V instruction set). The instructions can execute speculatively and out-of-order in the processing system 4000. The processing system 4000 can be a compute device, a microprocessor, a microcontroller, or an IP core. The processing system 4000 can be implemented as an integrated circuit. The processing system 4000 and each element or component in the processing system 4000 is illustrative and can include additional, fewer or different devices, entities, element, components, and the like which can be similarly or differently architected without departing from the scope of the specification and claims herein. Moreover, the illustrated devices, entities, element, and components can perform other functions without departing from the scope of the specification and claims herein.

The processing system 4000 includes a cluster 4100 connected to a power management unit 4200 and a power domain sequencer 4300. The power management unit 4200 can be connected to the power domain sequencer 4300. The power management unit 4200 can be a power microcontroller (PMC) and/or external hardware or logic with a state machine as described herein with respect to FIG. 3. The cluster 4100 can represent or be one or more clusters.

The cluster 4100 can include a core 4400 connected to uncore components 4500. In implementations, the core 4400 can represent or be one or more cores. The core 4400 can include a core side slave port or interface (collectively “port”) 4410 connected to a bus blocker 4420, which in turn is connected to a core side master port 4430.

The uncore components 4500 can include a control interconnection network 4510, a system interconnection network 4520, a front port 4530, a last level cache 4540, a memory port 4545, other uncore components 4550, one or more ports 4555, and a system port 4560. The control interconnection network 4510 and the system interconnection network 4520 are interconnected. The front port 4530 and the last level cache 4540 are connected to the system interconnection network 4520. The last level cache 4540 is connected to the memory port 4545. At least some of the other uncore components 4550 are connected to corresponding ports of the one or more ports 4555. The other uncore components 4550 are connected to the core 4400, the control interconnection network 4510, and the system interconnection network 4520 as appropriate and applicable. The other uncore components 4550 can include, but is not limited to, clock circuits, interrupt controllers and circuits, debug circuits, debug manager, wrappers, command line interrupt circuits and controllers, cache coherence manager, and caches.

The cluster 4100 further includes a bus blocker 4537 (shown as BB 4537) connected to the front port 4530, a bus blocker 4547 connected to the memory port 4545, one or more bus blockers 4557 connected to the one or more ports 4555 (on a one-to-one basis), and a bus blocker 4567 connected to the system port 4560. The bus blocker 4537, the bus blocker 4547, and the one or more bus blockers 4557 are connected to an interconnection network such as for example, interconnection network 1300.

The control interconnection network 4510 can include a bus blocker 4512 connected to a uncore side slave port 4514. The system interconnection network 4520 can include a bus blocker 4522 connected to a uncore side master port 4524. The control interconnection network 4510 and the system interconnection network 4520 can be chip-scale interconnect such as TileLink as described herein. The bus blockers 4420, 4522, and 4512 can be implemented as described herein. The uncore side slave port 4514 is connected to the core side slave port 4410. The uncore side master port 4524 is connected to the core side master port 4430.

The power management unit 1400 can communicate with the managed cores and/or clusters through the interconnection networks such as the control interconnection network 4510 and the system interconnection network 4520, via direct signals (e.g., cease_from_tile_x) using ports 4500, a dedicated interconnection network as shown in FIG. 1, or combinations thereof.

The description herein uses core side and uncore side when referring to bus blockers. A core side blocker may also be referred to as an internal blocker as with respect to the power domain being power gated and an uncore side blocker may also be referred to as an external blocker as with respect to the power domain being power gated.

In general, bus blockers are an active method of functionally isolating a unit or domain prior to power off. Blockers are typically located external to the power domain being powered off so they can remain active while the domain is off (i.e., external bus blockers). Internal bus blockers can be used as described herein. The outermost level of a chip requires either internal blockers or external system involvement or both. The use of internal blockers is port specific.

For a slave port, control external to the domain being powered off is needed to confirm that traffic has stopped on the port. An external control may be used which may not require a bus blocker. An internal blocker may be used at the slave port to improve the timing. For instance, engaging an internal blocker can immediately stop inbound traffic while waiting for the system to complete a possibly slower operation to eventually stop all traffic.

In implementations, a master port includes an internal bus blocker. In an TileLink system, all requests require responses. Therefore, if all traffic originating from inside the domain is stopped, a quiesced internal bus blocker is equivalent to a quiesced external bus blocker.

In implementations, a master port includes an internal bus blocker and an external bus blocker. The internal bus blocker is engaged last in this case, after the external blocker has been engaged and quiesced the port (no more pending transactions). For example, a late transaction emanating from the core could be denied exit at the external blocker, while remaining valid in a FIFO between the internal and external blockers. The internal blocker tracks transactions that have been emitted without a response. Only after the internal blocker recognizes that no pending transactions remain is there assurance that there are no valid transactions between the two blockers.

Operationally, with reference to FIGS. 1-4, an inbound transaction directed to a core (inbound relative to the core), such as the core 4400, is received at the front port 4530 from an external entity. In implementations, the inbound transaction can be a request or a response to a previously sent request. For example, the inbound transaction can be received via the interconnection network 1300. The uncore side slave port 4514 can receive the inbound transaction from the front port 4530 via the system interconnection network 4520 and the control interconnection network 4510. The core side slave port 4410 can receive the inbound transaction from the uncore side slave port 4514 for processing by the core 4400. The core 4400, for example, can send an outbound transaction (outbound relative to the core) via the core side master port 4430. The uncore side master port 4524 can receive the outbound transaction from the core side master port 4430. The core side master port 4430 can send the outbound transaction to external entities via the front port 4530 or other ports. As transactions are processed by the core, bus blockers associated with the ports, such as bus blockers 1112, 1142, 1144, 1310, 1320, 1330, 4420, 4514, and 4524, can maintain a pending register, such as the pending register 2200, to keep track of pending transactions.

Cores have a number of sleep states including active, wait for interrupt (WFI), and suspension to RAM or disk. A CEASE state is a sleep state as the core progresses from, for example, from a WFI state to a suspension state.

Cache flushing or other preparation before a core can be safely powered down without losing data is done by other means prior to executing the CEASE instruction. This can be a code sequence or interaction with other hardware such as a state machine to flush caches more efficiently. Caches are flushed so that there is no modified data in the core that is about to be power gated. Upon retiring of the CEASE instruction (i.e., core executes a CEASE instruction and enters the CEASE state indicating no further instructions are being executed), the core can export a signal that the core is in the CEASE state, which an SoC and/or power management unit can use to power gate the core.

The power management unit can execute a power down sequence as described herein to power gate the core and if appropriate and as dictated by power management policy, the cluster, the uncore components, the last level cache, and the shared last level cache. The power management policy can be maintained or stored in a configuration register or in an LLC power down policy register, such as the LLC power down policy register 2400, in a relevant bus blocker, for example. The power down sequence can include checking that relevant bus blockers are in a quiescent state with respect to transactions and enabling the relevant bus blockers to block external signals (transaction(s)) coming into the core and sending responses (transaction(s)) accordingly. A quiescent state refers to having no pending transactions at the relevant bus blockers. In implementations, each core can be tied to a corresponding reset or reset line to power up the powered down core when needed. A core in a CEASE state or power off state can be brought back to active via a reset.

As described herein, a cluster can include one or cores. Accordingly, one or more cores in a cluster can enter the CEASE state. In addition, one or more cores in a cluster can be activated using appropriate resets. Bus blockers external to the cluster, such as bus blockers 1310, 1320, and 1330, can be used to monitor, intercept, and appropriately respond (denials or response transactions) to external incoming signals (transactions) to the power gated cluster or a transitioning cluster. For example, the bus blockers can send messages to the other entity that the core is inactive or pending power gating.

As described herein, each of the cores can have access to a last level cache such as the last level cache 1120 and to a shared last level cache such as the shared last level cache 1200. In instances when the core or cluster is power gated, the relevant last level cache or shared last level cache can be partially power gated, fully power gated, and/or maintained in a retention state. State registers for the last level cache and/or the shared last level cache can be maintained as appropriate.

A retention state means that sufficient power is provided at a lower voltage to avoid state loss but is insufficient power for normal operation. The power domain sequencer 1500 can provide the retention state voltage by communicating with an on-chip voltage regulator, such as low-dropout (LDO) regulators, or with an external voltage regulator to control power rail switches or by using separate retention state voltage power rails. If the last level cache and/or the shared last level cache are in a retention state, bus blockers associated with a memory port receiving, for example a last level cache probe, can instruct the power management unit 1400 which in turn can instruct the power domain sequencer 1500 to power sequence up the last level cache to enable the last level cache probe to complete. After completion, the power management unit 1400 and the power domain sequencer 1500 can restore the retention state for the last level cache.

A core power down sequence is a software driven sequence, which can be entered directly or via an interrupt, such as based on a timer interrupt from a WFI power state. There are multiple phases when powering down a core including a core internal power down sequence and a core external power down sequence.

The core being powered down, for example core 4400, executes a core internal power down sequence that is terminated by the CEASE instruction. The core internal power down sequence can include, but is not limited to, disabling sources of core activity such as external interrupts, prefetchers, speculation units, and direct memory access (DMA) units (which can be referred as uncore components 1130 or other uncore components 4550), flushing a local cache, executing a FENCE instruction to complete flush and ensure interrupts disabled, disabling debug mechanisms, messaging a power controller with wake-up conditions or interrupts, and sending a notification to the power management unit 1400 or 4200 that the core is ready for power down (i.e., upon retirement of the CEASE instruction).

The sending of the ready signal enables or causes the power management unit 1400 or 4200 to initiate the core external power down sequence. When powering down a single core, such as the core 4400, bus blockers associated with master and slave ports for the core 4400 are activated and polled for quiescence in a defined sequence to ensure that all activity into and out of the core 4400 is complete. In an example, the relevant bus blockers are bus blockers 4420, 4524, and 4514. Bus blockers on the cluster boundary, such as the bus blocker 4537, the bus blocker 4547, and the one or more bus blockers 4557, are not activated when power gating a core within a cluster. In implementations, the master port can include a bus blocker for a core side master port and no bus blocker for an uncore side master port. The power management unit 4200 can send the activation and polling signals via the shared system interconnections, directly via ports 4600, or via separate or dedicated system interconnections (as shown in FIG. 1).

As stated, bus blockers are activated and polled in a defined sequence. The defined sequence depends on the bus blocker configuration with respect to the master port and the slave port. In implementations using shared system interconnections, the defined sequence first activates and polls the bus blocker associated with the uncore side master port (outbound transactions from the core) and then the bus blocker associated with the uncore side slave port (inbound transactions to the core). In implementations using shared system interconnections, the defined sequence first activates and polls the bus blocker associated with the uncore side master port (outbound transactions from the core), then the bus blocker associated with the core side master port (outbound transactions from the core), and finally the bus blocker associated with the uncore side slave port (inbound transactions to the core). In an example, the power management unit 4200 can activate the bus blocker 4522 by writing a zero in the allow register of the bus blocker 4522. This means that transactions are now disabled or blocked with respect to the uncore side master port 4524. The power management unit 4200 can then poll or confirm the status of the pending register in the bus blocker 4522 to ensure that there are no pending transactions. If there are no pending transactions in the bus blocker 4522, the power management unit 4200 can activate the bus blocker 4420 by writing a zero in the allow register of the bus blocker 4420. The power management unit 4200 can then poll or confirm the status of the pending register in the bus blocker 4420 to ensure that there are no pending transactions. If there are no pending transactions in the bus blocker 4420, the power management unit 4200 can activate the bus blocker 4514 by writing a zero in the allow register of the bus blocker 4514. The power management unit 4200 can then poll or confirm the status of the pending register in the bus blocker 4514 to ensure that there are no pending transactions.

In implementations using dedicated system interconnections, the defined sequence first activates and polls the bus blocker associated with the uncore side slave port (external), flush the state of the core or cluster, as appropriate, and then the bus blocker associated with the core side master port (internal). In implementations using dedicated system interconnections, the defined sequence first activates and polls the bus blocker associated with the uncore side slave port (external), flush the state of the core or cluster, as appropriate, then the bus blocker associated with the uncore side master port (external), and finally the bus blocker associated with the core side master port (internal). In an example, the power management unit 4200 can activate the bus blocker 4512 by writing a zero in the allow register of the bus blocker 4512. This means that transactions are now disabled or blocked with respect to the uncore side slave port 4514. The power management unit 4200 can then poll or confirm the status of the pending register in the bus blocker 4522 to ensure that there are no pending transactions. If there are no pending transactions in the bus blocker 4522, the power management unit 4200 can activate the bus blocker 4420 by writing a zero in the allow register of the bus blocker 4420. The power management unit 4200 can then poll or confirm the status of the pending register in the bus blocker 4420 to ensure that there are no pending transactions. Blocking the slave port first stops potential writes to configuration registers before beginning to flush the state from the core or domain to be powered off. Blocking the master ports last allows cache probes that can only originate from a master coherent port to proceed while any cache state which is being flushed to maintain coherence with the rest of the system.

If there are no pending transactions in the bus blocker 4514, the power management unit 4200 can electrically isolate the domain being powered down (the core 4400) from any other domains that remain powered by sending an isolation enable signal which enables isolation gates. The isolation gates are inserted during the hardware synthesis flow to support separate power domains. The isolation gates are AND or OR gates that clamp the output signals to a value voltage level for 1 or 0. The isolation gates are needed so a unit that is powered off cannot send unknown voltages into units that are powered up and functional. When a unit is powered down, it's output voltages cannot be determined and they won't just fall to a logical 0. After electrical isolation, the power management unit 4200 can notify the power domain sequencer 4300 to begin disabling power rail switches (V_{DD} Core 4310). In implementations, the power rails can be incrementally enabled/disabled to minimize power delivery network disturbances. The power domain sequencer 4300 can notify the power management unit 4200 when power transitions are complete.

In implementations, where the last core of a cluster is being powered down, the last level cache and the uncore components can be powered down or remain in a retention state depending on the policy written in a policy register of a relevant bus blocker. In the event the policy is set to power down and cluster is to be powered down, the last level cache should be flushed prior to powering down if not already flushed. In addition, the bus blockers for ports connected to the interconnection network can be activated and polled in a defined sequence. In an example, the bus blocker 4537, the bus blocker 4547, the one or more bus blockers 4557, and the bus blocker 4567 can be activated. As stated, bus blockers are activated and polled in a defined sequence. The defined sequence first activates and polls the bus blocker associated with the front port, the system port, and then memory port. The list of ports and bus blockers can include other ports and bus blockers which logically fit within the defined sequence.

In an example, the power management unit 4200 can activate the bus blocker 4537 by writing a zero in the allow register of the bus blocker 4537. This means that transactions are now disabled or blocked with respect to the front port 4530. The power management unit 4200 can then poll or confirm the status of the pending register in the bus blocker 4537 to ensure that there are no pending transactions. If there are no pending transactions in the bus blocker 4537, the power management unit 4200 can activate the bus blocker 4567 by writing a zero in the allow register of the bus blocker 4567. This means that transactions are now disabled or blocked with respect to the system port 4560. If there are no pending transactions in the bus blocker 4567, the power management unit 4200 can activate the bus blocker 4547 by writing a zero in the allow register of the bus blocker 4567. This means that transactions are now disabled or blocked with respect to the memory port 4545.

If there are no pending transactions in the bus blocker 4567, the power management unit 4200 can electrically isolate the domain being powered down (the cluster 4100) from any other domains that remain powered by sending an isolation enable signal which enables isolation gates. After electrical isolation, the power management unit 4200 can notify the power domain sequencer 4300 to begin disabling power rail switches (V_{DD} Cluster 4320). In implementations, the power rails can be incrementally enabled/disabled to minimize power delivery network disturbances. The power domain sequencer 4300 can notify the power management unit 4200 when power transitions are complete.

As described herein, a core within a cluster or a cluster can be activated upon a reset or a wake-up signal. The power management unit 4200 can receive a wake-up interrupt or other signal to initiate the wake sequence. The power management unit 4200 can notify or signal the power domain sequencer 4300 to begin the power up sequence. The power domain sequencer 4300 can notify or signal the power management unit 4200 when power has been restored. After the power has been restored, the clocks and reset sequencing can commence prior to reset de-assertion (as shown for example in FIG. 3). After reset de-assertion is complete, debug access can be restored. The power management unit 4200 can write a one in the allow registers of the relevant bus blockers to deactivate the bus blocker(s) and enable transactions.

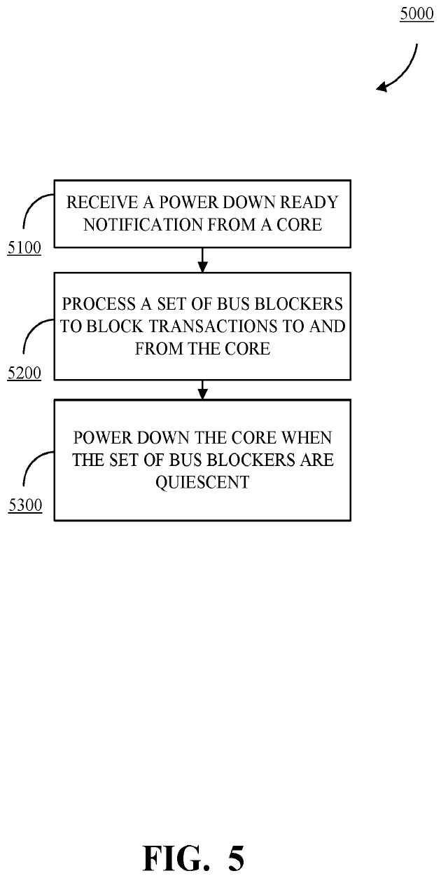

FIG. 5 is a diagram of an example technique 5000 for power gating in accordance with embodiments of this disclosure. The technique 5000 includes: receiving 5100 a power down ready notification from a core; processing 5200 a set of bus blockers to block transactions to and from the core; and powering 5300 down the core when the set of bus blockers are quiescent. The technique 5000 can be implemented, for example, in the processing system 1000 of FIG. 1, the bus blocker 2000, the state machine 3000, and the processing system 4000, as appropriate and applicable. In FIG. 5, the core is a representative power domain to be powered off. The power domain can be a core(s), cluster(s), complex(es), or combinations thereof.

The technique 5000 includes receiving 5100 a power down ready notification from a core. The core can execute a core internal power down sequence terminating with the retirement of the CEASE instruction as described herein. After retiring the CEASE instruction, the core can send a notification to the power management unit to initiate a core external power down sequence. The power down ready notification can be sent by a core with respect to itself or for a cluster or complex containing the core. In implementations, the power management unit can receive the power down ready notification from an external entity (external with respect to a second entity to be powered down) to power down one or more cores, clusters, complexes, or combinations thereof (e.g., the second entity).

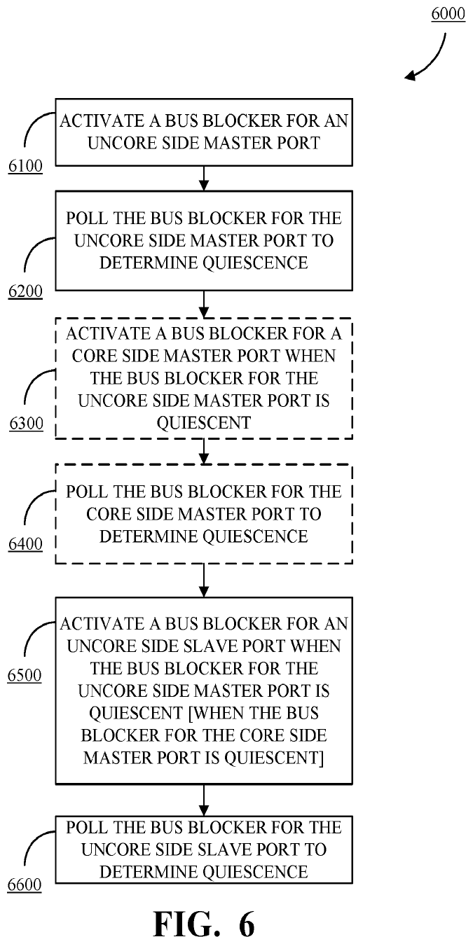

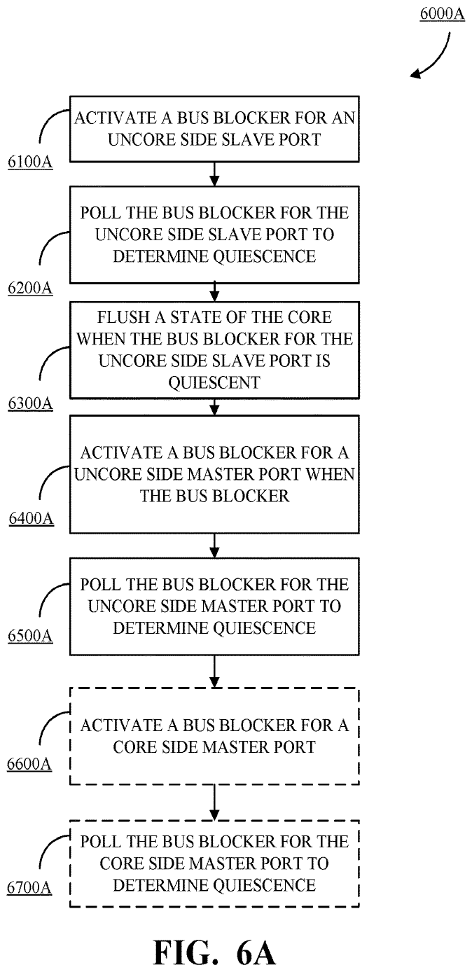

The technique 5000 includes processing 5200 a set of bus blockers to block transactions to and from the core. The power management unit can execute the core external power down sequence, which includes sequential activation and polling of each bus blocker in the set of bus blockers associated with the core. The sequence can be, for example, a bus blocker associated with an uncore side master port (uncore side outbound transactions), then a bus blocker associated with a core side master port (core side outbound transactions), and then a bus blocker associated with an uncore side slave port (uncore side inbound transaction). Each later bus blocker is processed if a preceding bus blocker is quiescent. A bus blocker processing sequence is described in FIG. 6 with respect to using a shared interconnection system. A bus blocker processing sequence is described in FIG. 6A with respect to using a dedicated interconnection system.

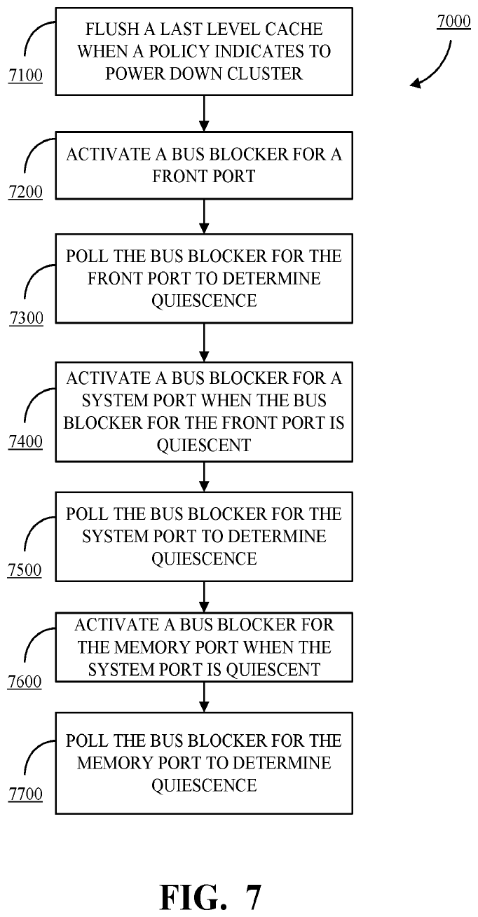

The technique 5000 includes powering 5300 down the core when the set of bus blockers are quiescent. The power management unit can notify the power domain sequencer to power down the core rails when all bus blockers are quiescent. In the event that the core is the last core, the power management unit can use a configuration register to indicate a power down policy for a last level cache and/or uncore components, For example, the configuration register can be in one of the bus blockers. FIG. 7 describes a powering down sequence if the policy indicates that the last level cache and/or uncore components are to be powered down.

FIG. 6 is a diagram of an example technique 6000 for power gating in accordance with embodiments of this disclosure. FIG. 6 can use a shared interconnection network. The technique 6000 includes: activating 6100 a bus blocker for an uncore side master port; polling 6200 the bus blocker for the uncore side master port to determine quiescence; activating 6300 a bus blocker for a core side master port when the bus blocker for the uncore side master port is quiescent; polling 6400 the bus blocker for the core side master port to determine quiescence; activating 6500 a bus blocker for an uncore side slave port when the bus blocker for the core side master port is quiescent; and polling 6600 the bus blocker for the uncore side slave port to determine quiescence. The technique 6000 can be implemented, for example, in the processing system 1000 of FIG. 1, the bus blocker 2000, the state machine 3000, the processing system 4000, and with the technique 5000, as appropriate and applicable. In FIG. 6, the core is a representative power domain to be powered off. The power domain can be a core(s), cluster(s), complex(es), or combinations thereof.

The technique 6000 includes activating 6100 a bus blocker for an uncore side master port. The power management unit can activate an allow register in the bus blocker to disable outbound transactions from the core.

The technique 6000 includes polling 6200 the bus blocker for the uncore side master port to determine quiescence. The power management unit can poll a pending register in the bus blocker to determine if there any pending transactions.

The technique 6000 includes activating 6300 a bus blocker for a core side master port when the bus blocker for the uncore side master port is quiescent. The power management unit can activate an allow register in the bus blocker to disable outbound transactions from the core when the bus blocker for the uncore side master port is quiescent. In implementations, the master port does not include a bus blocker for a core side master port and the technique 6000 moves to 6500 and omits 6300 and 6400.

The technique 6000 includes polling 6400 the bus blocker for the core side master port to determine quiescence. The power management unit can poll a pending register in the bus blocker to determine if there any pending transactions.

The technique 6000 includes activating 6500 a bus blocker for an uncore side slave port when the bus blocker for the core side master port is quiescent. The power management unit can activate an allow register in the bus blocker to disable outbound transactions from the core when the bus blocker for the core side master port is quiescent.

The technique 6000 includes polling 6600 the bus blocker for the uncore side slave port to determine quiescence. The power management unit can poll a pending register in the bus blocker to determine if there any pending transactions. The power management unit can proceed with a remaining steps in the core external power down sequencing when the bus blocker for the uncore side slave port is quiescent.

FIG. 6A is a diagram of an example technique 6000A for power gating in accordance with embodiments of this disclosure. FIG. 6A can use a dedicated interconnection network. The technique 6000A includes: activating 6100A a bus blocker for an uncore side slave port; polling 6200A the bus blocker for the uncore side slave port to determine quiescence; flushing 6300A a state of the core when the bus blocker for the uncore side slave port is quiescent; activating 6400A a bus blocker for an uncore side master port; polling 6500A the bus blocker for the uncore side master port to determine quiescence; activating 6600A a bus blocker for a core side master port; and polling 6700A the bus blocker for the core side master port to determine quiescence. The technique 6000 can be implemented, for example, in the processing system 1000 of FIG. 1, the bus blocker 2000, the state machine 3000, the processing system 4000, and with the technique 5000, as appropriate and applicable. In FIG. 6A, the core is a representative power domain to be powered off. The power domain can be a core(s), cluster(s), complex(es), or combinations thereof.

The technique 6000A includes activating 6100A a bus blocker for an uncore side slave port. The power management unit can activate an allow register in the bus blocker to disable transactions from the core.

The technique 6000A includes polling 6200A the bus blocker for the uncore side slave port to determine quiescence. The power management unit can poll a pending register in the bus blocker to determine if there any pending transactions.

The technique 6000A includes flushing 6300A a state of the core when the bus blocker for the uncore side slave port is quiescent.

The technique 6000A includes activating 6400A a bus blocker for an uncore side master port. The power management unit can activate an allow register in the bus blocker to disable outbound transactions from the core when the bus blocker for the uncore side slave port is quiescent and flushing is complete.

The technique 6000A includes polling 6500A the bus blocker for the uncore side master port to determine quiescence. The power management unit can poll a pending register in the bus blocker to determine if there any pending transactions. The power management unit can proceed with remaining steps in the core external power down sequencing when the bus blocker for the uncore side master port is quiescent.

The technique 6000A includes activating 6600A a bus blocker for a core side master port. The power management unit can activate an allow register in the bus blocker to disable transactions when the bus blocker for the uncore side master port is quiescent. In implementations, the master port can include a bus blocker for an uncore side master port and no bus blocker for a core side master port. In implementations, the master port does not include a bus blocker for the core side master port and the technique 6000A omits 6600A and 6700A. The optional core side master port blocker is only engaged after the uncore side master port blocker indicates quiescence. At that time, it's possible for one or more transactions to still be pending across the core side master port blocker. The core side master port blocker is solely used to block new outbound transaction requests from the core side and to determine when any pending transactions are complete. More specifically, after the uncore side master blocker has been used to quiesce the master port on the uncore side, the only pending transactions can be outbound transactions from the core that are denied by the uncore side master port blocker. The outbound core transaction requests are monitored by the core side master blocker to detect when they complete. After all denied responses complete, the core side master blocker pending register indicates that the core side master port is quiesced.

The technique 6000A includes polling 6700A the bus blocker for the core side master port to determine quiescence. The power management unit can poll a pending register in the bus blocker to determine if there any pending transactions. The power management unit can proceed with remaining steps in the core external power down sequencing when the bus blocker for the core side master port is quiescent.

FIG. 7 is a diagram of an example technique 7000 for power gating in accordance with embodiments of this disclosure. The technique 7000 includes: flushing 7100 a last level cache when a policy indicates to power down cluster; activating 7200 a bus blocker for a front port; polling 7300 the bus blocker for the front port to determine quiescence; activating 7400 a bus blocker for a system port when the bus blocker for the front port is quiescent; polling 7500 the bus blocker for the system port to determine quiescence; activating 7600 a bus blocker for the memory port when the system port is quiescent; and polling 7700 the bus blocker for the memory port to determine quiescence. The technique 7000 can be implemented, for example, in the processing system 1000 of FIG. 1, the bus blocker 2000, the state machine 3000, the processing system 4000, with the technique 5000, and with the technique 6000, as appropriate and applicable. In FIG. 7, the cluster is a representative power domain to be powered off. The power domain can be a cluster(s), complex(es), or combinations thereof.

The technique 7000 includes flushing 7100 a last level cache when a policy indicates to power down cluster. The last level cache, if not already flushed, can be flushed prior to checking relevant bus blockers.

The technique 7000 includes activating 7200 a bus blocker for a front port. The power management unit can activate an allow register in the bus blocker to disable transactions to and from the cluster.

The technique 7000 includes polling 7300 the bus blocker for the front port to determine quiescence. The power management unit can poll a pending register in the bus blocker to determine if there any pending transactions to or from the cluster.

The technique 7000 includes activating 7400 a bus blocker for a system port when the bus blocker for the front port is quiescent. The power management unit can activate an allow register in the bus blocker to disable transactions to and from the core when the bus blocker for the front port is quiescent.

The technique 7000 includes polling 7500 the bus blocker for the system port to determine quiescence. The power management unit can poll a pending register in the bus blocker to determine if there any pending transactions to or from the cluster.

The technique 7000 includes activating 7600 a bus blocker for a memory port when the bus blocker for the system port is quiescent. The power management unit can activate an allow register in the bus blocker to disable transactions to and from the cluster when the bus blocker for the system port is quiescent.

The technique 7000 includes polling 7700 the bus blocker for the memory port to determine quiescence. The power management unit can poll a pending register in the bus blocker to determine if there any pending transactions to or from the core. The power management unit can notify the power domain sequencer to power down the last level cache and uncore components when the bus blocker for the memory port is quiescent.

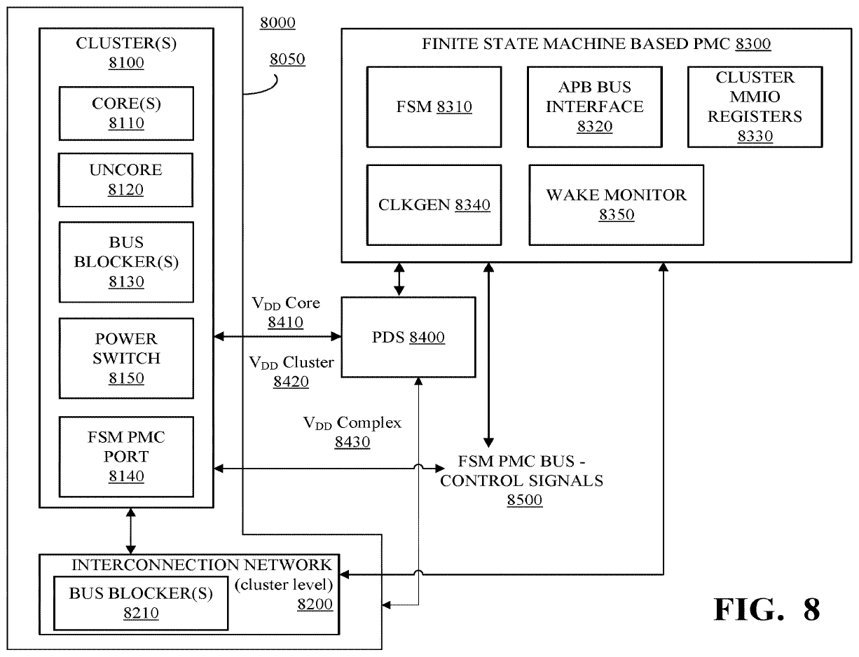

FIG. 8 is a block diagram of an example of a processing system 8000 for implementing power gating with a finite state machine based power management controller in accordance with embodiments of this disclosure. The processing system 8000 and elements thereof can implement the processing system 1000 shown in and described for FIG. 1 and the processing system 4000 shown in and described for FIG. 4. The processing system 8000 and elements thereof can operate and function as described for the processing system 1000 and the processing system 4000 and implement the technique 5000, the technique 6000, and the technique 7000 as described herein. The processing system 8000 and each element or component in the processing system 8000 is illustrative and can include additional, fewer, or different devices, entities, element, components, and the like which can be similarly or differently architected without departing from the scope of the specification and claims herein. Moreover, the illustrated devices, entities, element, and components can perform other functions without departing from the scope of the specification and claims herein.

The processing system 8000 includes a complex(es) 8050, which includes cluster(s) 8100 interconnected via an interconnection network 8200. Each of the cluster(s) 8100 can include a core(s) 8110 and an uncore 8120. The cluster(s) 8100 and the interconnection network 8200 can include bus blockers 8130 and 8210, respectively, as described herein. A finite state machine based power management controller (FSM PMC) 8300 (performing as a power management unit) and a power domain sequencer (PDS) 8400 can be connected to each other and to each of the one or more clusters 8100 directly and/or via the interconnection network 8200. The FSM PMC 8300 can include an FSM 8310, an advanced peripheral bus (APB) bus interface unit (APB BIU) 8320, cluster memory-mapped input/output (MMIO) registers 8330, a clock generator (CLKGEN) 8340, and a wake monitor 8350. The power domain sequencer 8400 can be a microcontroller, a controller, and an external hardware or logic. In implementations, the FSM PMC 8300 and the power domain sequencer 8400 can be an integrated unit. The FSM PMC 8300 and components therein can send and receive control signals, such as activation and polling signals, via the interconnection network 8200, an FSM PMC control bus 8500, and an FSM PMC port 8140. The FSM PMC 8300 can receive instructions from the core 8110, cluster 8100, and the complex 8050 via the interconnection network 8200 to initiate or process power gating functionality as described herein.

The FSM 8310 can provide power up and power down control sequencing for the processing system 1000. That is, the FSM 8310 can control power transitions for the core-complex together with the core software sequences. The APB BIU 8320 can drive the FSM PMC control bus 8500 and the FSM PMC port 8120. The cluster MMIO registers 8330 can provide communication with the cluster 8100 and the FSM PMC 8300 via MMIO operations. The CLKGEN 8340 can drive core and uncore clocks in the cluster(s) 8100 under control of the FSM PMC 8300. The power domain sequencer 8400 can supply power to a power switch 8150 under control of the FSM PMC 8300. The power switch 8150 is representative of power lines/switches to the core(s) 8110, cluster(s) 8100, and/or complex(es) 8050 as appropriate and are connected to the power domain sequencer 8400 via 8410, 8420, and 8430, respectively. The power domain sequencer 8400 can control power sequencing of the complex(es) 8050 via 8430, the cluster(s) 8100 via 8420, and/or the core(s) 8110 via 8410 for power gating as described herein. The wake monitor 8350 can capture interrupts while the core(s) 8110, cluster(s) 8100, and/or complex(es) 8050 is powered off and generate a wake signal.

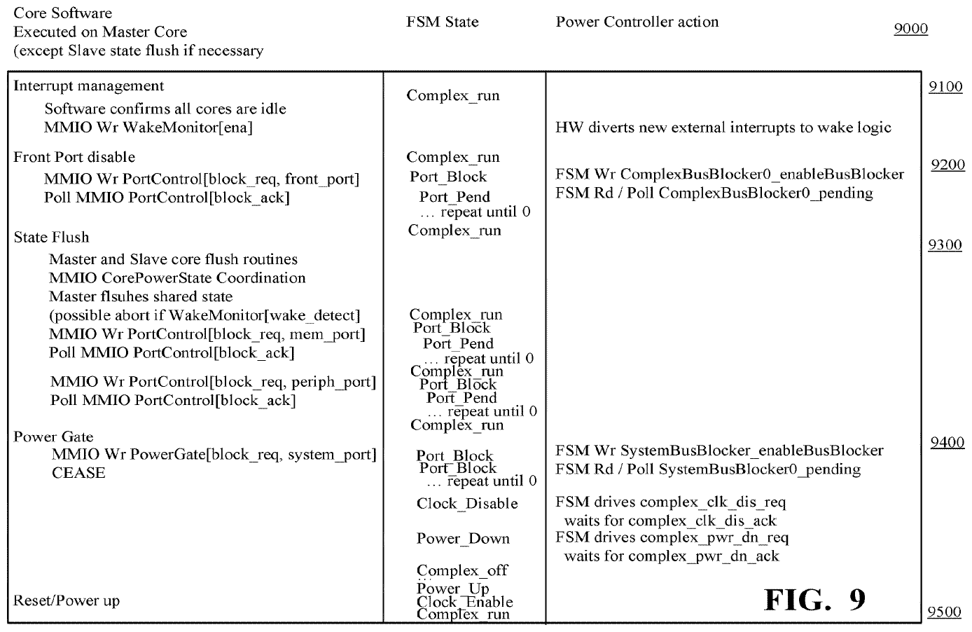

FIG. 9 is a flow diagram of an example of a power gating sequence 9000 for use with the finite state machine power management controller of FIG. 8 in accordance with embodiments of this disclosure. The power gating sequence 9000 is controlled by core level software with assistance from a set of independent external functions invoked through the cluster MMIO register 8330 operations. The cluster MMIO functions invoke external hardware operations in the FSM PMC 8300.

The core software implements the power gating sequence 9000 through the following steps: interrupt management 9100, front port disable 9200, state flush 9300, and power gate 9400. Prior to the final step, core software can optionally sample the cluster MMIO registers 8330 wake monitor register or function for the presence of a wakeup event. If a wakeup event is present, all earlier port and wake monitor 8350 operations are reversed, and core operation may be restored without a power transition. If no wakeup event is present, the cluster MMIO register 8330 function PortControl is used with the FSM PMC control bus 8500 addresses of all remaining non-system master ports to ensure quiescence of the ports. The cluster MMIO register 8330 function PowerGate is invoked to both disable the system port and power off the cluster until a wake event triggers the FSM PMC 8300 to initiate power up through the reset flow for resumption of processing. In implementations, power gating is attempted after a cluster has been operating in run mode following a cold boot. Power gating is not a power state entered during a boot sequence. The cluster MMIO register 8330 function PortControl uses the bus blockers, such as the bus blockers 8130 and 8210, for quiescent processing and in some implementations, also uses external system control to determine that both inbound transactions are ceased to quiesce a front port and inbound probe transactions are ceased to quiesce a memory port if the processing system 8000 is using a coherent interconnect protocol.

A power gating operation is initiated after all cores are expected to be idle for a long duration (determined by OS/software) before resuming processing. The first step in power gating is the interrupt management step 9100 through the configuration of a wakeup event. FSM PMC 8300 uses the cluster MMIO registers 8330 wake monitor function. The wake monitor function both diverts new external interrupts to allow a safe period for software to complete the power gate steps and provides a wakeup signal. The wakeup signal can be sampled prior to the final power gate step 9400 and used as an input to the FSM 8310 after a power down. Core software must ensure that all cores in the cluster 8100 have completed processing and are idle before proceeding to the slave/front port disable step 9200.

The next step in power gating is the front port disable 9200. Core software uses the cluster MMIO PortControl function to disable inbound transactions on slave/front ports on the cluster 8100 prior to flushing the cluster state. This cluster MMIO PortControl function uses the bus blocker address configured in the PMCPortBlockerAddrOffset table and the FSM 8310. The cluster MMIO PortControl function returns an acknowledgement in the cluster MMIO registers 8330. The FSM 8310 enables a cluster internal bus blocker and polls the associated pending register to ensure that inbound transactions are prevented from updating any cluster state. An external system is required to stop all inbound activity prior to powering the cluster down and may augment or replace the internal bus blocker operation with an external operation that stops all activity on the front port while maintaining a cluster MMIO PortControl interface.

The next step in power gating is the state flush 9300. Core software is responsible for identifying and flushing all necessary state from caches or other local or shared storage prior to power off of the cluster 8100. A master core may be designated to coordinate with slave cores, if necessary, for local state scrubbing using a CorePowerState MMIO register inside the cluster 8100. After slave cores are idle, the master core flushes all shared states. Flush sequences check for operation completion to ensure that transactions have reached the cluster port prior to initiating the cluster MMIO PowerGate function, which blocks the master port. After flushing the state, software uses the cluster MMIO PortControl function to disable master ports except the port servicing the cluster MMIO registers 8330. The core software should not disable master ports until all flush operations have reached a cluster port or risk an incomplete flush. Flush operation completion indicators imply that writes have been acknowledged. After a memory port is blocked, operations to external memory will not function. Therefore, core software may need to either align and pack instructions upto and including the PowerGate function in the same cache line as the ControlPort operation or fetch needed lines into the instruction cache before blocking the memory port.

Power gating 9400 is the last step in the power gating sequence 9000 and the only one that cannot be reversed once invoked. Prior to invoking PowerGate function, the core software can sample the cluster MMIO wake monitor function for a wake event. If present, ports can be reenabled and the wake monitor function can be disabled, reestablishing external interrupts to the cluster 8100. If a wake event is not detected, core software continues to the PowerGate function. The PowerGate function initially disables the system port, requiring the FSM PMC 8300 to complete the power transition because the cluster 8100 can no longer access cluster MMIO state. Once the system port is confirmed to be quiesced, the FSM 8310 proceeds to disable clocks, isolate the cluster 8100 (which disables debug access), and disconnect power. After requesting the PowerGate operation, core software must remain idle through either a CEASE or WFI instruction. The FSM 8310 completes the power down operation and monitors incoming external interrupt wires for a wakeup event. The wake monitor function generates a wake_detect signal as the logical OR of all new external interrupts. When detected, wake_detect transitions the FSM 8310 from a cluster_off state to PDS_Power_up and the FSM 8310 completes the reset power up sequence to restore the cluster back to the cluster_run state.

The FSM PMC 8300 includes error handling. The PowerControl function can generate an error on the APB or TileLink bus when accessing a bus blocker. There are two bus operations involved, one to enable or disable the blocker and a second to poll for pending operations. All errors are returned to the FSM PMC 8300 and force the FSM 8310 back to the cluster_run state. In addition, they set the PowerControl [bus_error] bit which can be tested by teh core software prior to invoking the PowerGate function.

A bus error encountered by the PowerGate function does not stop a power down operation. Instead, power is transitioned and the PowerGate [bus_error] bit is set for the core software following a wake up. The most likely source of a bus error is an incorrect system port address for the bus blocker. In this case, the port is not confirmed to be quiesced prior to power down which could lead to a system error if a transaction was in-flight when power was removed. Therefore, the core software should ensure that the correct bus blocker address is used with the PowerGate function.

In some implementations, a bus error in the PowerGate function can force the FSM 8310 to return to the cluster_run state while generating an interrupt to the core. The interrupt should be unmasked and the core should terminate with a WFI instruction. An interrupt service routine is required to detect the error, reverse the power gate steps, and return to normal operation.

The cluster MMIO register 8330 functions include wake monitor function, PortControl, PowerGate, PMCdebug, PMCTimer, PMCCycleCountHi, PMCCycleCountLo, and CorePowerState

The wake monitor register or function provides software with control over new external interrupt delivery to the cluster 8100. Interrupts can be diverted to wake logic while the cluster 8100 is powered off and generate a wake_detect signal to initiate power up. The wake_detect input to the FSM 8310 is used to branch from the cluster_off state and does not affect sequencing at other times. The wake monitor register is configured as shown in Table 1.

TABLE 1

| | FIELD | ATTRI- | RESET | |
|---|---|---|---|---|
| BITS | NAME | BUTES | STATE | DESCRIPTION |
| [31] | ena_req | read/ | 0 | Request diversion of new |
| | | write | | external interrupts to the |
| | | | | wake logic to generate a |
| | | | | wake_detect signal for |
| | | | | software and an FSM input. |
| [30] | ena_ack | read | 0 | Acknowledge that wake |
| | | only | | detection is enabled and the |
| | | | | cluster is not receiving new |
| | | | | external interrupts. |
| [29] | dis_req | read/ | 0 | Request reestablishment of |
| | | write | | external interrupts to the |
| | | | | core-complex and clearing |
| | | | | of the wake_detect signal. |
| [28] | dis_ack | read | 0 | Acknowledge that wake |
| | | only | | detection is disabled and |
| | | | | interrupts forward to the |
| | | | | cluster. |
| [0] | wake_detect | read | 0 | Set by hardware when a |
| | | only | | wake event is detected. |

A wake monitor register read provides status for the ports. Table 2 details the valid states.

TABLE 2

| ena_req | ena_ack | dis_req | dis_ack | wake_detect |
|---|---|---|---|---|
| 0 | E0 | 0 | 0 | Blocker is disabled after reset, |
| | | | | port traffic is unaffected. |
| 1 | 0 | 0 | 0 | Blocker is being enabled, |
| | | | | possibly blocking inbound |
| | | | | transactions. |
| 0 | 1 | 0 | 0 | Blocker is enabled with no |
| | | | | transactions pending. |
| 0 | 0 | 1 | 0 | Blocker is being disabled, |
| | | | | possibly allowing inbound |
| | | | | transactions. |
| 0 | 0 | 0 | 1 | Blocker is disabled, port |
| | | | | traffic is unaffected. |

The PortControl MMIO register provides software control of the cluster ports. Ports other than the system port can be disabled to prepare for power gating and can also be enabled to abort power gating in the event of a late wakeup interrupt. Once set, the block_reqor allow_req bits remain set until the port bus blocker responds with an acknowledgement that the port has no pending operations. Addresses that miss all cluster bus blockers return a bus error.

The PortControl MMIO register is configured as shown in Table 3.

TABLE 3

| | FIELD | ATTRI- | RESET | |
|---|---|---|---|---|
| BITS | NAME | BUTES | STATE | DESCRIPTION |
| [31] | block_req | read/ | 0 | Request bus blocker enable |
| | | write | | and monitoring of the |
| | | | | associated pending |
| | | | | register. |
| [30] | block_ack | read | 0 | Acknowledge that the bus |
| | | only | | blocker is enabled and there |
| | | | | are no pending operations. |
| [29] | allow_req | read/ | 0 | Request bus blocker |
| | | write | | disable, allowing port traffic |
| | | | | to operate normally. |
| [28] | allow_ack | read | 0 | Acknowledge that the bus |
| | | only | | blocker is disabled and the |
| | | | | port is operating normally. |
| [20] | bus_error | read | 0 | Bus error, generally caused |
| | | only | | by an operation that misses |
| | | | | all bus blockers. |
| [19:0] | bb_addr | read/ | 0 | Bus blocker address in |
| | | write | | PMC address space |
| | | | | associated with the port to |
| | | | | be enabled/disabled. |

The PowerGate MMIO register provides software the ability to both disable the system port and initiate a power gating sequence by the external FSM. After power down, the cluster remains off until a wakeup interrupt is detected by the wake monitor function. At that time, the FSM 8310 executes a power up sequence to reset and restore operation to the cluster. Once set, the block_req bit remains set until the port bus blocker responds with an acknowledgement. Addresses that miss all cluster bus blockers return a bus error. Note that hardware cannot confirm that an address is associated with the system port. Any valid bus blocker address allows the state machine to advance and power gate the cluster. The PowerGate MMIO register is configured as shown in Table 4.

TABLE 4

| | FIELD | ATTRI- | RESET | |
|---|---|---|---|---|
| BITS | NAME | BUTES | STATE | DESCRIPTION |
| [31] | block_req | read/ | 0 | Request the system port bus |
| | | write | | blocker enable and |
| | | | | monitoring of the associated |
| | | | | pending register followed |
| | | | | by a power transition |
| | | | | controlled by the FSM. |
| [20] | block_error | read | 0 | Bus error on the previous |
| | | only | | power gate operation, |
| | | | | generally caused by an |
| | | | | operation that misses all bus |
| | | | | blockers. |
| [19:0] | bb_addr | read/ | 0 | Bus blocker address in |
| | | write | | PMC address space |
| | | | | associated with the system |
| | | | | port. |

PowerGate Power Transitions. The FSM 8310 interfaces directly with the PDS 8400 and the CLKGEN 8340 to request and acknowledge transitions. The PDS interface allows an external power domain sequencer to independently control the power ramp to avoid di/dt issues.

After disabling the system port, the FSM 8310 executes a power down sequence including: assert IsoCcplex (disabling debug), assert complex reset (pwrOnRst) and core reset signals, request and confirm all clocks are disabled by the CLKGEN 8340, and request and confirm power disconnect by the PDS 8400.

While the cluster is powered off, interrupts are diverted to the wake monitor function and the cluster is powered up by the cluster_wake signal. In some implementations, the cluster is powered up by a debug event. The power up sequence is similar to a cold boot sequence as controlled by the FSM 8310. The FSM 8310 interface directly drives cluster reset and core reset signals to the cluster throughout the power off period.

The FSM power up sequence includes request and confirm power enable to the core-complex by the PDS 8400, request and confirm all clocks are enabled by the CLKGEN 8340, de-assert IsoCcplex (enabling debug), insert delay for WFI tile clock gate enable propagation following reset; assert complex and core clock gate enables, de-assert cluster and core resets, and FSM 8310 returns to the cluster_run state to await the next core software operation. Bus blockers reset to a disabled state, allowing traffic. The external system stops all inbound traffic before power off until after reset.

The PMCDebug register provides core software with control and status information about the FSM PMC 8300. The WarmReset bit is set if the cluster has been power gated. The WarmReset bit is set when FSM 8310 enters the cluster_off state and remains set until either a system reset or software clears it. System software may use this bit to distinguish a reset flow following power gating (warm reset) from a complete system power off reset (cold reset). Software should clear the bit after a warm reset to prepare for the next power transition. The PMCDebug MMIO register is configured as shown in Table 5.

TABLE 5

| | FIELD | ATTRI- | RESET | |
|---|---|---|---|---|
| BITS | NAME | BUTES | STATE | DESCRIPTION |
| [31] | WarmReset | read/ | 0 | Indicates that the FSM has |
| | | write | | transitioned through the |
| | | | | cluster_off state (i.e., the |
| | | | | cluster has been powered up |
| | | | | after being power gated). |
| | | | | SW can write the bit to clear |
| | | | | it after a warm reset to |
| | | | | prepare for the next power |
| | | | | transition. |
| [15:0] | | read | 0 | State confirming power off |
| | | only | | conditions for SW |
| | | | | verification. |
| [7:0] | FSM_State | read | 0 | The FSM state encoding is |
| | | only | | provided. |

The PMCTimer provides a counter function to generate a wakeup interrupt to the wake monitor function for software/FPGA testing. The register value is reset to 0 which disables the interrupt. On a write of a non-zero value, the counter is enabled but does not start counting until the FSM 8310 is in the cluster_off state (when the cluster power is off). When the FSM is in cluster_off state, the counter decrements and generates a wakeup interrupt when it reaches 0. The interrupt remains asserted until the FSM 8310 is in cluster_run when it is de-asserted. The PMCTimer register value remains unchanged for subsequent power transitions. The PMCTimer value provides a delay count in system clocks.

The cluster MTIME register is powered off with the cluster. Software must choose between allowing MTIME to stop incrementing while power is off, or restoring a real-time count value. A real-time count can be provided by an always-on (AON) system timer or storing the sum of the MTIME just prior to power-off plus the PMCTimer value representing the power-off time. The sum may be adjusted for MTIME frequency.

The PMCTimer register is configured as shown in Table 6.

TABLE 6

| | FIELD | | RESET | |
|---|---|---|---|---|
| BITS | NAME | ATTRIBUTES | STATE | DESCRIPTION |
| [31:0] | delay | read/write | 0 | Delay after power-off |
| | | | | before a wakeup interrupt is |
| | | | | asserted to the wake |
| | | | | monitor. |

The PMCCycleCountHi is a 32b read-only register providing the upper bits of a 64b PMCcycle counter. The counter is initialized to 0 at PMC reset and is free running using the PMCclk (the system clock which uses the uncore clock). Overflows wrap and are managed by software. The PMCCycleCountHi register is configured as shown in Table 7.

TABLE 7

| | FIELD | | RESET | |
|---|---|---|---|---|
| BITS | NAME | ATTRIBUTES | STATE | DESCRIPTION |
| [31:0] | CCHi | read only | 0 | Upper 32b bits of 64b read- |
| | | | | only cycle counter. |

The PMCCycleCountLo is a 32b read-only register providing the upper bits of a 64b PMCcycle counter. The counter is initialized to 0 at PMC reset and is free running using the PMCclk (the system clock which uses the uncore clock). Overflows wrap and are managed by software. The PMCCycleCountLo register is configured as shown in Table 8.

TABLE 8

| | FIELD | | RESET | |
|---|---|---|---|---|
| BITS | NAME | ATTRIBUTES | STATE | DESCRIPTION |
| [31:0] | CCLo | read only | 0 | Lower 32b bits of 64b read- |
| | | | | only cycle counter. |

The core power state as reflected in the external control signals is provided inside the cluster in the Subsystem Low Power Control (SLPC) unit. The register is used by core software to coordinate idle conditions across the complex prior to power gating. The CorePowerState register is configured as shown in Table 9.

TABLE 9

| | FIELD | ATTRI- | RESET | |
|---|---|---|---|---|
| BITS | NAME | BUTES | STATE | DESCRIPTION |
| [31:16] | WFI | read | 0 | The WFI_from_tile/core_x |
| | state | only | | signals are provided. |
| [15:0] | CEASE | read | 0 | The CEASE_from_tile/core_x |
| | state | only | | signals are provided. |

Referring back to FIG. 8, the FSM 8310 can include the input interfaces listed in Table 10 and the output interfaces listed in Table 11.

TABLE 10

| INTERFACE | DESCRIPTION |
|---|---|
| port_control_req | MMIO PortControl assertion of block_req or |
| | allow_req |
| port_allow_req | MMIO PortControl assertion of allow_req |
| port_block_req | MMIO PortControl assertion of block_req |
| power_gate_req | MMIO PowerGate assertion of block_req |
| wake_detect | wake event from the Wake Monitor |
| APB_bus_ack | the APB bus operation is complete (read or |
| | write) |
| APB_read_data | the APB bus read data lsb (used for blocker |
| | pending register) |
| complex_clk_dis_ack | response from CLKGEN that complex_clk is |
| | disabled |
| complex_clk_ena_ack | response from CLKGEN that complex_clk is |
| | enabled |
| complex_pwr_dn_ack | response from PDS that complex power is off |
| complex_pwr_up_ack | response from PDS that complex power is on |

TABLE 11

| INTERFACE | DESCRIPTION |
|---|---|
| bus_read | bus read command to APBBIU |
| bus_write | bus write command to APBBIU |
| bus_write_data | bus write data to APBBIU |
| complex_clk_dis_req | request to CLKGEN to disable the |
| | complex_clk |
| complex_clk_ena_req | request to CLKGEN to enable the |
| | complex_clk |
| complex_pwr_dn_req | request to PDS to disable the complex power |
| complex_pwr_up_req | request to PDS to enable the complex power |

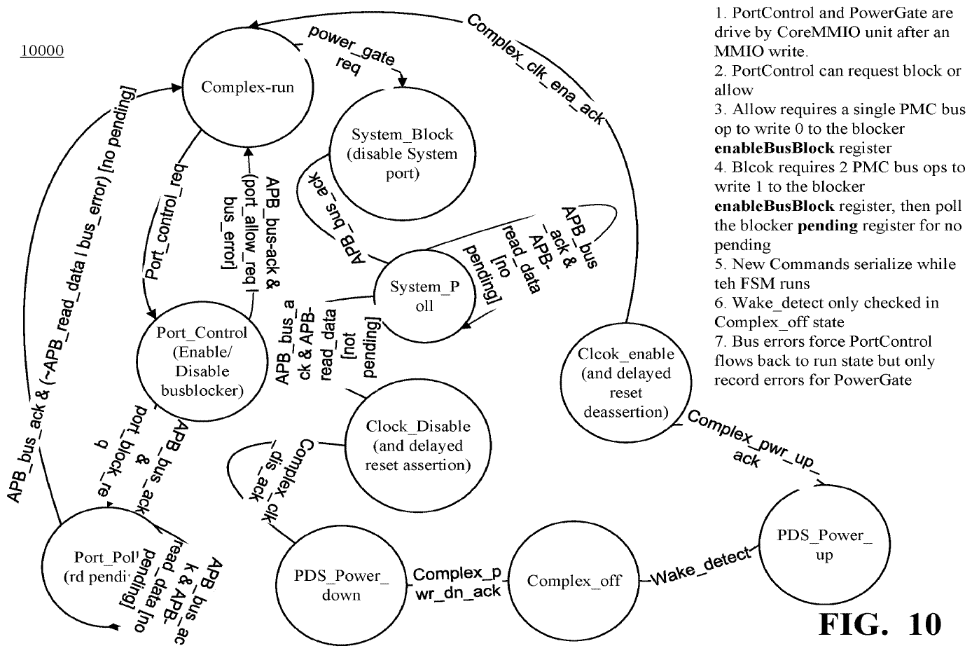

FIG. 10 is a block diagram of an example of a finite state machine state sequence 10000 for use with the finite state machine power management controller of FIG. 8 in accordance with embodiments of this disclosure. The finite state machine state sequence 10000 includes the FSM sequencer states shown in Table 12 and the FSM sequencer transitions shown in Table 13. The finite state machine state sequence 10000 takes precedence over the state tables of Table 12 and 13. The term complex and cluster are used interchangeably herein.

TABLE 12

| STATE | FUNCTION |
|---|---|
| Cluster_off | Cluster is powered off, waiting for a wake event. |
| PDS_power_up | Initiate PDS for cluster power up; wait for PDS |
| | cluster_pwr_up_ack |
| Clock_enable | enable clks, de-assert cluster reset (pwrOnRst), |
| | deassertIsoCcplex (enabling debug) |
| Port_Control | Issue APB write to bus blocker enableBusBlock |
| | register to block or allow new transactions |
| Port_Poll | Issue APB read to bus blocker pending register |
| Cluster_run | Cluster is in run state, power controller is waiting |
| | for MMIO function |
| System_block | Issue APB write to bus blocker enableBusBlock |
| | register to block the system port (prior to power |
| | gating) |
| System_poll | Issue APB read to bus blocker pending register |
| Clock_disble | Disable clks, assert complex reset (pwrOnRst), |
| | assertIsoCcplex(disabling debug, sets |
| | DebugUnavailable, blocks/errorsjtag operations) |
| PDS_power_down | Assert complex reset (pwrOnRst) (remains asserted |
| | through completion of power up) |

TABLE 13

| CURRENT | | NEXT | |
|---|---|---|---|
| STATE | INPUT | STATE | COMMENT |
| Cluster_off | wake_detect | PDS_power_up | External power on from |
| | | | either cold reset or wake |
| | | | event. |
| PDS_power_up | cluster_pwr_up_ack | Clock_enable | PDS sequence complete |
| Clock_enable | clsuter_clk_ena_ack | Cluster_run | clock and reset |
| | | | sequence complete |
| Cluster_run | port_control_req | Port_Control | Block or allow the port |
| | | | as indicated in the |
| | | | MMIO register |
| Port_Control | APB_bus_ack | Cluster_run | port allows traffic |
| | &port_allow_req | | |
| Port_Control | APB_bus_ack | Port_Poll | port is blocked (but may |
| | &APB_bus_data | | have pending |
| | | | transactions) |
| Port_Poll | APB_bus_ack | Port_Poll | port is busy (has |
| | &APB_bus_data | | pending ops) |
| Port_Poll | APB_bus_ack | Complex_run | port is blocked within |
| | &~APB_bus_data | | complex and has no |
| | | | pending transactions |
| Cluster_run | power_gate_req | System_block | Block the system port |
| | | | prior to power gating |
| System_block | APB_bus_ack | System_poll | block System port |
| System_poll | APB_bus_ack | System_poll | port remains pending |
| | &APB_bus_data | | |
| System_poll | APB_bus_ack | Clock_disable | port is blocked with no |
| | &~APB_bus_data | | pending transactions |
| Clock_disable | cluster_clk_dis_ack | PDS_power_down | clock and reset |
| | | | sequence complete |
| PDS_power_down | cluster_pwr_dn_ack | Cluster_off | PDS power off |
| | | | sequence complete |

The APBBIU 8320 receives bus commands from the FSM 8310, generates APB bus transactions and responds to the FSM 8310 with APB_bus_ack completion acknowledgement and the lsb data forreads on APB_bus_data. Bus operations use the BB_Addr[BB_Idx] value as the address since the bus operations supported by the FSM 8310 are to cluster bus blockers. Accesses to illegal bus blocker addresses return a bus error on the cluster PMC port 8140 (pmc_port_apb_0_pslverr). Error conditions on the APB bus can occur on both read and write transactions. The APBBIU 8320 can include the input interfaces shown in Table 14 and the output interfaces shown in Table 15.

TABLE 14

| INTERFACE | DESCRIPTION |
|---|---|
| APB bus | APB bus from cluster PMC port |
| bus_read | bus read command to APBBIU |
| bus_write | bus write command to APBBIU |
| bus_write_data | bus write data to APBBIU |
| bus_addr | bus address from cluster MMIO BB_Addr for |
| | reads and writes |

TABLE 15

| INTERFACE | DESCRIPTION |
|---|---|
| APB bus | APB bus to cluster PMC port |
| APB_bus_ack | the APB bus operation is complete (read or write), |
| | including error responses to FSM |
| APB_bus_err | the APB bus operation is complete (read or write) |
| | with an error |
| APB_read_data | the APB bus read data lsb (used for blocker |
| | pending register) to FSM |

The wake monitor unit 8350 is controlled by the cluster MMIO wake monitor register. All cluster external interrupts are passed through the wake monitor unit 8350. When disabled, the unit simply passes interrupts through to the cluster with a single gate delay. The wake_detectoutput remains de-asserted. When enabled by a core write, all cluster interrupts are frozen in the current state. This allows software to enable the wake monitor while still processing existing interrupts. The current state is also captured for comparison against new external interrupts. New interrupt assertions generate the wake_detect output. Wake_detect is not affected by interrupt de-assertions. Interrupts are expected to be level sensitive, but the wake_detect output is sticky until either a core write disables the monitor (e.g., following a power down abort) or the FSM restores power to the cluster in the PDS_Power_Upstate. The wake monitor unit 8350 includes the input interfaces shown in Table 16 and the output interfaces shown in Table 17.

TABLE 16

| INTERFACE | DESCRIPTION |
|---|---|
| external interrupts | from system |
| enable | From cluster MMIO |

TABLE 17

| INTERFACE | DESCRIPTION |
|---|---|
| cluster interrupts | Interrupts to cluster |
| Wake_detect | wake detect output to cluster MMIO register and FSM |

The power domain sequencer 8400 is defined relative to the customer technology. Customers may implement any combination of power switch controls and delays when transitioning power states, but should respond with a cluster_pwr_*_ack signal on any transition. Transitions may not be aborted after request. In some implementations, the interface to the FSM 8310 consists of 2 pairs or request/ack wires. The FSM 8310 drives cluster_pwr_up_req and receives cluster_pwr_up_ack when power is stable. The FSM 8310 drives cluster_pwr_dn_req and receives cluster_pwr_dn_ack when power is off. The power domain sequencer 8400 drives a single power gate enable ccplex gate to control the power switch on the cluster 8100. The power domain sequencer 8400 includes the input interfaces shown in Table 18 and the output interfaces shown in Table 19.

TABLE 18

| INTERFACE | DESCRIPTION |
|---|---|
| cluster_pwr_up_req | power up request from the FSM |
| cluster_pwr_dn_req | power down request from the FSM |

TABLE 19

| INTERFACE | DESCRIPTION |
|---|---|
| cluster_pwr_up_ack | power up acknowledge to the FSM |
| cluster_pwr_dn_ack | power down acknowledge to the FSM |

The CLKGEN 8340 provides core, uncore and debug clocks, resets and isolation (IsoCcplex) to the cluster when requested by the FSM 8310. The CLKGEN unit 8340 may insert delays between clocks and reset and isolation as needed, but responds with an acknowledge signal back to the FSM 8310 when the operation is complete. In some implementations, the interface to the CLKGEN 8310 consists of 2 pairs or request/ack wires. The FSM 8310 drives cluster_clk_ena_req and receives cluster_clk_ena_ack when the clocks are stable. The FSM 8310 drives cluster_clk_dis_req and receives cluster_clk_dis_ack when the clocks are off. The CLKGEN 8340 includes the input interfaces shown in Table 19 and the output interfaces shown in Table 20.

TABLE 19

| INTERFACE | DESCRIPTION |
|---|---|
| cluster_clk_ena_req | clock enable request from the FSM (enables |
| | core_clks, cluster_clk and debug_clk) |
| cluster_clk_dis_req | clock disable request from the FSM |

TABLE 20

| INTERFACE | DESCRIPTION |
|---|---|
| complex_clk_ena_ack | clock enable acknowledge to the FSM |
| | (core_clks, uncore_clk, and debug_clk |
| | are operational) |
| complex_clk_dis_ack | clock disable acknowledge to the FSM |
| core_clk(s) | clocks to all cores/tiles |
| uncore_clk | clock to cluster uncore |
| debug_clk | cluster debug clock |
| pwrOnRst | reset to the cluster |
| IsoCcplex | assert cluster isolation enable to clamp |
| | all cluster outputs |

The cluster MMIO registers or register block 8330 provide direct communication and control between cores 8110 and the FSM 8310. Functions provided by the cluster MMIO registers 8330 are described herein. The cluster MMIO registers 8330 are mapped to uncacheable memory. In some implementations, the cluster MMIO registers 8330 use the system port, which is present in all subsystems. In some implementations, the cluster MMIO registers 8330 use a peripheral port. The cluster MMIO registers 8330 are not mapped to a cacheable port. The cluster MMIO registers 8330 are not assigned to a memory port. The cluster MMIO registers 8330 include the input interfaces shown in Table 21 and the output interfaces shown in Table 22.

TABLE 21

| INTERFACE | DESCRIPTION |
|---|---|
| system bus | cluster system bus |
| FSM_state | FSM encoded state |
| CEASE_from_core/tile_x | outputs from cluster |
| wake_detect | output from wake monitor |
| APB_bus_err | the APB bus operation is complete (read or |
| | write) with an error (to set the bus_error |
| | bit in PortControl or PowerGate registers) |

TABLE 22

| INTERFACE | DESCRIPTION |
|---|---|
| system bus | cluster system bus |
| enable | register output to wake monitor |
| start_power_down | output to FSM |
| bus_addr | bb_addr bus address to APBBIU for reads and |
| | writes updated on PortControl and PowerGate |
| | writes |

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more computer readable mediums having computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

1. A processing system comprising:
a cluster including one or more cores; a power domain sequencer; and
a power management unit connected to the cluster, the one or more cores, and the power domain sequencer, the power management unit configured to:
receive a power down ready notification from a core of the one or more cores; and
process a set of bus blockers to block transactions to and from the core,
wherein a bus blocker is associated with a port on an interconnection network connected to the one or more cores, uncore components, and the cluster; and the power domain sequencer configured to:
power down the core when receiving a notification from the power management unit that the set of bus blockers are quiescent.

2. The processing system of claim 1, the power management unit further configured to:
sequentially activate and poll each bus blocker in the set of bus blockers associated with the core.

3. The processing system of claim 1, when a shared interconnection network is used in the processing system, the power management unit further configured to:
activate a first bus blocker for an uncore side master port; poll the first bus blocker to determine quiescence;
activate a second bus blocker for a core side master port when the first bus blocker is quiescent;
poll the second bus blocker to determine quiescence;
activate a third bus blocker for an uncore side slave port when the second bus blocker is quiescent; and
poll the third bus blocker to determine quiescence,
wherein the set of bus blockers includes the first bus blocker, the second bus blocker, and the third bus blocker.

4. The processing system of claim 3, the power management unit further configured to:
enable an allow register in the first bus blocker, the second bus blocker, and the third bus blocker, respectively, when the first bus blocker, the second bus blocker, and the third bus blocker are activated, respectively.

5. The processing system of claim 4, the power management unit further configured to:
poll a pending register in the first bus blocker, the second bus blocker, and the third bus blocker, respectively, when the first bus blocker, the second bus blocker, and the third bus blocker are polled, respectively.

6. The processing system of claim 3, wherein when the core is a last core of the one or more cores in the cluster:
the power management unit further configured to:
poll a last level cache and uncore components power down register in one of the set of bus blockers; and
process another set of bus blockers to block transactions to and from the cluster when the last level cache and uncore components power down register indicates to power down a last level cache and the uncore components; and
the power domain sequencer further configured to:
power down the last level cache and the uncore components upon receiving a notification from the power management unit when the another set of bus blockers are quiescent.

7. The processing system of claim 6, the power management unit further configured to:
sequentially activate and poll each bus blocker in the another set of bus blockers associated with the cluster.

8. The processing system of claim 7, the power management unit further configured to:
activate a fourth bus blocker for a front port;
poll the fourth bus blocker to determine quiescence;
activate a fifth bus blocker for a system port when the fourth bus blocker is quiescent;
poll the fifth bus blocker to determine quiescence;
activate a sixth bus blocker for a memory port when the fifth bus blocker is quiescent; and
poll the sixth bus blocker to determine quiescence,
wherein the another set of bus blockers includes the fourth bus blocker, the fifth bus blocker, and the sixth bus blocker.

9. The processing system of claim 8, when a dedicated interconnection network is used in the processing system, the power management unit further configured to:
activate a first bus blocker for an uncore side slave port; poll the first bus blocker to determine quiescence;
flush the core when the first bus blocker is quiescent;
activate a second bus blocker for an uncore side master port; and poll the second bus blocker to determine quiescence,
wherein the set of bus blockers includes the first bus blocker, the second bus blocker, and the third bus blocker.

10. The processing system of claim 9, further comprising:
activate a third bus blocker for a core side master port when the second bus blocker is quiescent; and
poll the third bus blocker to determine quiescence,
wherein the set of bus blockers includes the first bus blocker, the second bus blocker, and the third bus blocker.

11. A method for power gating, the method comprising:
receiving, at a power management unit, a power down ready notification from a core which is ready to power down;
processing, by the power management unit, a set of bus blockers to block transactions to and from the core, wherein a bus blocker is associated with a port on an interconnection network connected to the core; and
powering down, by a power domain sequencer in cooperation with the power management unit, the core when the set of bus blockers are quiescent.

12. The method of claim 11, the method further comprising:
sequentially activating and polling, by the power management unit, each bus blocker in the set of bus blockers associated with the core.

13. The method of claim 11, the method further comprising:
activating, by the power management unit, a first bus blocker for an uncore side master port;
polling, by the power management unit, the first bus blocker to determine qmescence;
activating, by the power management unit, a second bus blocker for a core side master port when the first bus blocker is quiescent;
polling, by the power management unit, the second bus blocker to determine qmescence;
activating, by the power management unit, a third bus blocker for an uncore side slave port when the second bus blocker is quiescent; and
polling, by the power management unit, the third bus blocker to determine quiescence,
wherein the set of bus blockers includes the first bus blocker, the second bus blocker, and the third bus blocker.

14. The method of claim 13, the method further comprising:
enabling, by the power management unit, an allow register in the first bus blocker, the second bus blocker, and the third bus blocker, respectively, when the first bus blocker, the second bus blocker, and the third bus blocker are activated, respectively; and
polling, by the power management unit, a pending register in the first bus blocker, the second bus blocker, and the third bus blocker, respectively, when the first bus blocker, the second bus blocker, and the third bus blocker are polled, respectively

15. The method of claim 11, wherein when the core is a last core in a cluster, the method further comprising:
polling, by the power management unit, a last level cache and uncore components power down register in one of the set of bus blockers;
processing, by the power management unit, another set of bus blockers to block transactions to and from the cluster when the last level cache and uncore components power down register indicates to power down a last level cache and uncore components; and
powering down, by the power domain sequencer, the last level cache and the uncore components upon receiving a notification from the power management unit when the another set of bus blockers are quiescent.

16. The method of claim 15, the method further comprising:
activating, by the power management unit, a fourth bus blocker for a front port; polling, by the power management unit, the fourth bus blocker to determine qmescence;
activating, by the power management unit, a fifth bus blocker for a system port when the fourth bus blocker is quiescent;
polling, by the power management unit, the fifth bus blocker to determine qmescence;
activating, by the power management unit, a sixth bus blocker for a memory port when the fifth bus blocker is quiescent; and
polling, by the power management unit, the sixth bus blocker to determine quiescence,
wherein the another set of bus blockers includes the fourth bus blocker, the fifth bus blocker, and the sixth bus blocker.

17. The method of claim 11, wherein each bus blocker in the set of bus blockers includes an allow register for activating the bus blocker, a pending register for indicating pending transactions, a power state register for indicating a power state of an associated core or cluster, and a last level cache and uncore components power down policy register indicating a policy when a last core is powered down.

18. A method for power gating, the method comprising:
receiving, at a power management unit, a power down ready notification from a first entity that a second entity is ready to power down;
sequentially activating and polling, by the power management unit, each bus blocker in a set of bus blockers associated with the second entity after a second entity internal power down sequence is complete; and
notifying, a power domain sequencer by the power management unit when the set of bus blockers are quiescent, to power down the second entity.

19. The method of claim 18, wherein:
the first entity and the second entity is a core;
the first entity is a core and the second entity is at least a cluster; or
the first entity is an external system with respect to the second entity and the second entity is at least a core.

20. The method of claim 18, wherein when the core is a last core in a cluster, the method further comprising:
polling, by the power management unit, a last level cache and uncore components power down register in one of the set of bus blockers;
sequentially activating and polling, by the power management unit, each bus blocker in another set of bus blockers associated with the cluster; and
notifying, a power domain sequencer by the power management unit when the another set of bus blockers are quiescent, to power down a last level cache and uncore components.
